(19) United States
(12) Patent Application Publication
(10) Pub. No.: US 2022/0010831 A1
(43) Pub. Date: Jan. 13, 2022

(54) MEANS FOR HOLDING TIGHTENED STATE BETWEEN HANGER AND ANCHOR BOLT OF DROPPED CEILING

(71) Applicant: Min Si JUNG, Gangneung-si (KR)

(72) Inventor: Min Si JUNG, Gangneung-si (KR)

(21) Appl. No.: 17/079,260

(22) Filed: Oct. 23, 2020

(30) Foreign Application Priority Data
Jun. 11, 2020 (KR) 10-2020-0070821

(51) Int. Cl. F16B 33/00; F16L 3/133; F16B 23/00; F16B 9/00

(52) U.S. Cl. CPC F16B 33/002; F16L 3/133; F16B 2001/0035; F16B 9/054; F16B 23/0038

(57) ABSTRACT

Disclosed herein is a holding means provided with a spacer capable of occupying a space between an upper horizontal part and an upper vertical part of a hanger and a nut.

### CROSS-REFERENCE TO RELATED APPLICATION

This application claims priority to and the benefit of Korean Patent Application No. 200X-XXXXX, filed on XXX X, 200X, the disclosure of which is incorporated herein by reference in its entirety.

### BACKGROUND

### 1. Field of the Invention

The present disclosure relates to a means for maintaining a tightened state between a hanger and an anchor bolt, and more particularly, a means for holding a tightened state between a pipe hanger and an anchor bolt that is applied to a ceiling suspension system such as a fire extinguishing facility, a communication facility, or a water and sewage facility, or between a carrying bar hanger and an anchor bolt, which are employed in a lightweight steel frame system.

### 2. Discussion of Related Art

Recently, a dry construction technique and modularization have been in the spotlight in the field of architecture and are being suggested as an alternative solution to the issues facing modern society. As domestic society is gradually becoming increasingly elderly, it is difficult to secure professional manpower, and the number of foreign workers is increasing. As a result, construction quality is deteriorating due to inexperienced workers. Building a system capable of facilitating construction by introducing modularization in the architectural field that underdoes such a trend will minimize hiring of professional workers and reduce labor costs. In addition, the system may lead to factory production which will improve construction quality and minimize on-site processes, thereby reducing construction time.

Because of such advantages, modular construction is gradually spreading abroad, and research on modularization is being actively conducted in Korea. As a lot of advanced equipment is introduced to construction sites, processes requiring direct input of manpower have decreased. One of the processes still requiring skilled labor is related to ceiling construction. Ceiling construction involves various processes related to electrical wiring, arrangement of equipment, piping, lighting, lightweight steel, finishing, and the like. Each of these processes depends on the skill level of a professional worker. Accordingly, ceiling construction occupies a high proportion of labor costs, and the work quality is not uniform due to its dependency on the skill level of the worker. Further, delays may occur due to interference between processes.

As shown in FIG. 1 and disclosed in Korean Patent Application Publication No. 10-2020-0000026, in order to suspend a carrying bar from a ceiling in ceiling construction, an anchor bolt embedded in the concrete ceiling and a carrying bar hanger having an upper end fastened and fixed to the anchor bolt and a lower end fitted to the carrying bar are generally provided.

In addition, as disclosed in Korean Patent No. 1687663, in order to suspend a pipe for fire extinguishing equipment, communication equipment, water and sewage equipment from the ceiling in ceiling construction, an anchor bolt embedded in the concrete ceiling and a pipe hanger having an upper end fastened and fixed to the anchor bolt and a lower end fitted to the pipe are generally provided.

In particular, to couple the hanger to the anchor bolt, a through hole is formed in an upper horizontal part of the hanger, and a pair of nuts is fastened to the anchor bolt with the horizontal part interposed therebetween. Thereby, the hanger is prevented from moving in the longitudinal direction of the anchor bolt.

However, when the ceiling is vibrated, the nuts may be loosened from the anchor bolt and shift in the longitudinal direction of the anchor bolt, causing movement of the hanger in the longitudinal direction of the anchor bolt. As a result, the hanger may fail to support the carrying bar or the pipe.

### SUMMARY OF THE INVENTION

Therefore, the present invention has been made in view of the above problems.

In accordance with an aspect of the present disclosure, the above and other objects can be accomplished by the provision of a spacer capable of occupying a space arranged in the space between a nut and an upper horizontal part and an upper vertical part of a hanger.

The hanger and the nut may be formed of a magnetic material, and the spacer may be formed of a magnet, such that a worker can easily attach and detach the spacer.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic view showing a conventional lightweight steel ceiling system;

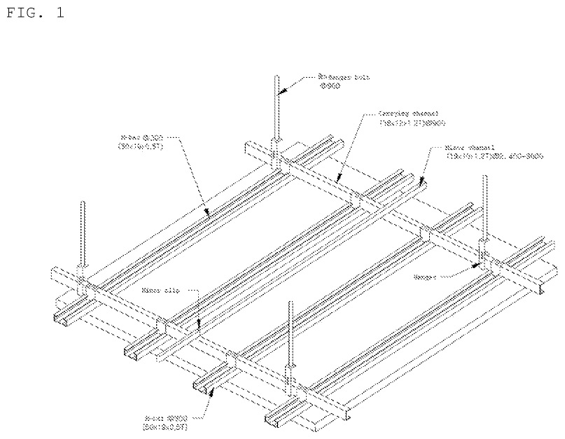

FIG. 2 is a perspective view showing a means for holding a carrying bar hanger and an anchor bolt according to an embodiment of the present disclosure;

FIG. 3 is a perspective view showing a modification of the embodiment of FIG. 2; and

FIG. 4 is a perspective view showing a means for holding a pipe hanger and an anchor bolt according to an embodiment of the present disclosure.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

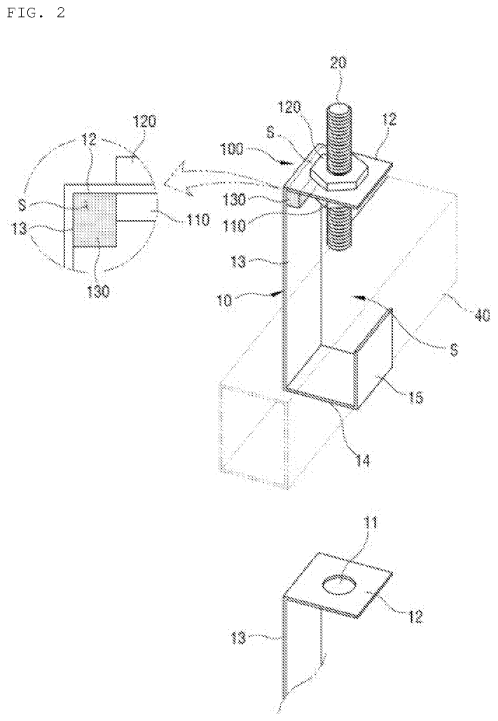

Hereinafter, embodiments according to the present disclosure will be described in detail with reference to FIGS. 2 to 4.

In FIG. 2, the holding means for a carrying bar hanger 10 and the anchor bolt 20 according to the embodiment of the present disclosure is indicated as 100.

As in conventional cases, the carrying bar hanger 10 includes an upper horizontal part 12 extending in a horizontal direction and having a through hole 11 through which the anchor bolt 20 passes; a vertical part 13 bent at one end of the upper horizontal part 12 and extending downward; a lower horizontal part 14 bent at a lower end of the vertical part 13 to face the upper horizontal part 12 and extending in a horizontal direction; and a jaw 15 bent at an opposite end of the lower horizontal part 14 and extending upward.

The holding means 100 includes a lower nut 110 formed to have a size and shape defining an empty space S between the upper horizontal part 12 and an upper portion of the vertical part 13 when fastened to the anchor bolt 20 arranged through the through hole 11 and brought into close contact with a bottom surface of the upper horizontal part 12; an upper nut 120 fastened to the anchor bolt 20 arranged through the through hole 11 and brought into close contact with a top surface of the upper horizontal part 12; and a spacer 130 interposed in the empty space S to closely contact an upper portion of the vertical part 13 and the lower nut 110 to prevent rotation of the lower nut 110.

The lower nut 110 may be formed as a hexagonal nut to allow the spacer 130 to easily make surface contact with any one of the six lateral faces of the lower nut 110.

In addition, the spacer 130 may be formed of a magnet, and the lower nut 110 and the hanger 10 may be formed to be magnetic to facilitate operation of a worker at a high place.

In the holding means 100 configured as described above, when the upper nut 120, the hanger 10 and the lower nut 110 are sequentially arranged through the anchor bolt 20, the upper nut 120 and the lower nut 110 are tightened to closely contact the top and bottom surfaces of the upper horizontal part 12 according to a height where the carrying bar 40 can be fitted into the space defined by the vertical part 13, the lower horizontal part 14, and the jaw 15. Then, when the spacer 130 is inserted into the empty space S, the upper nut 120 and the lower nut 110 may be prevented from rotating. Accordingly, the hanger 10 may remain coupled to the carrying bar 40 to support the carrying bar even when vibration occurs in the ceiling.

In particular, as the lower nut 110 and the hanger are magnetic while the spacer 130 is formed of a magnet, when an operator holds and positions the spacer 130 near the empty space S to insert the spacer 130 into the empty space S, the spacer 130 is attracted to and seated in the empty space S by magnetic force.

In addition, when the spacer 130 is removed from the empty space S, the spacer 130 can be pushed out in the longitudinal direction of the carrying bar 40 using a tool, which is not shown. Thereby, the spacer 130 may be decoupled.

While the spacer 130 is described in the embodiment as being brought into surface contact with the lower nut 110 and the upper portion of the vertical part 13, the present disclosure is not limited thereto. The spacer 130 may have a size and shape to make surface contact even with the bottom surface of the upper horizontal part 12. In this case, the lower nut 110 may be formed as a hexagonal nut such that the spacer 130 can easily make surface contact with one of the six lateral surfaces of the lower nut 110.

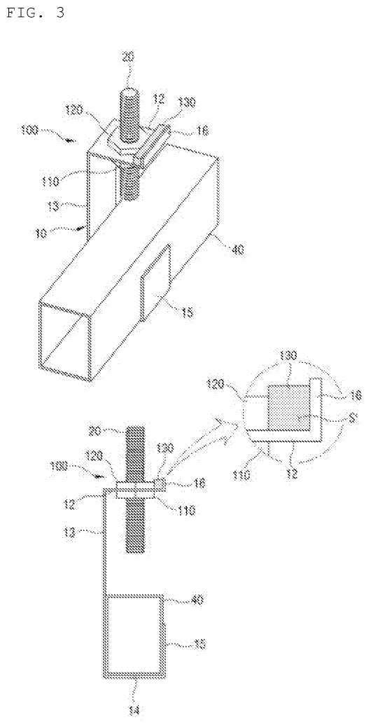

While the spacer 130 is described in the embodiment above as being brought into surface contact with the lower nut 110, the present disclosure is not limited thereto. As shown in FIG. 3, the spacer 130 may be brought into surface contact with the upper nut 120.

In this case, the hanger 10 may further include a bracket piece 16 bent at the opposite end of the upper horizontal part 12 and extending upward. The spacer 130 may be interposed in the empty space S′ between the upper nut 120, the bracket piece 16, and the upper horizontal part 12 to make surface contact with the bracket piece 16 and the upper nut 120. Thereby, rotation of the upper nut 120 may be prevented. In this position, the spacer 130 may also make surface contact with the top surface of the upper horizontal part 12.

Regarding the holding means 100 of this embodiment, while one spacer 130 is described as making surface contact with the lower nut 110 or the upper nut 120, the present disclosure is not limited thereto. Two spacers may be brought into surface contact with the lower nut 110 and the upper nut 120, respectively, while making surface contact with the hanger 10.

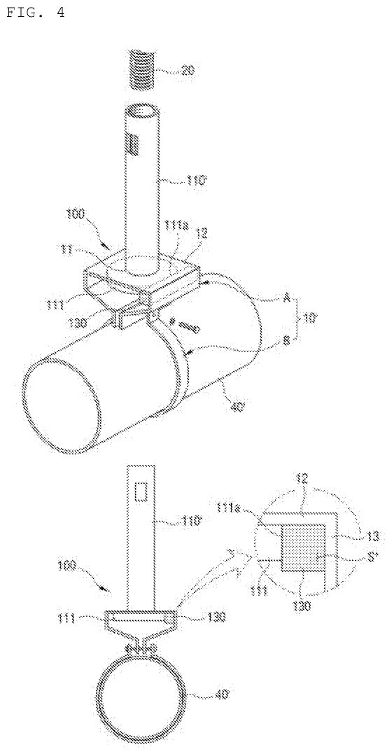

According to a second embodiment as shown in FIG. 4, in order to suspend a pipe for fire extinguishing equipment, communication equipment, water and sewage equipment, or the like from the ceiling, the holding means 100 shown in FIGS. 2 and 3 may be provided to a pipe hanger 10′ having a lower portion into which a pipe is fitted with the upper portion thereof mounted on an anchor bolt embedded in a concrete ceiling.

Unlike the carrying bar hanger 10, the pipe hanger 10′ includes a mount part A mounted on the anchor bolt 20 and a clamping part B detachably coupled to the lower end of the mount part A to clamp a pipe 40′.

The holding means 100 of the second embodiment includes a tubular nut 110′ having a threaded inner circumferential surface screwed to the anchor bolt 20; a flange 111 expanding from the lower end of the tubular nut 110′ to allow the bottom surface of the upper horizontal part 12 of the pipe hanger 10′ to be seated with the tubular nut 110′ arranged through the through hole 11 formed in the upper horizontal part 12 of the mount part A of the pipe hanger 10′; and a spacer 130 interposed in an empty space S″ defined between the upper horizontal part 12 of the pipe hanger 10′ and the upper portion of the vertical part 13 bent at one side of the upper horizontal part 12 and extending downward to make surface contact with the upper portion of the vertical part 13 and the flange 111 to prevent rotation of the pipe hanger 10′.

A portion of the flange 111 facing the vertical part 13 may be chamfered to have a flat portion 111a parallel to the vertical part 13. In this case, the spacer 130 may easily make surface contact with the flat portion 111a of the flange 111.

In addition, the spacer 130 may be formed of a magnet, and the tubular nut 110′ and the pipe hanger 10′ may be formed to be magnetic. Thereby, convenience may be enhanced for a worker operating at a high place.

In the holding means 100 of the second embodiment configured as described above, when mount part (A) is seated on the flange 111 by passing the tubular nut 110′ through the through hole 11 formed in the mount part (A) of the pipe hanger 10′, the tubular nut 110′ may be fastened to the anchor bolt 20 according to the height level at which the pipe 40′ can be clamped to the clamping part (B). Then, when the spacer 130 is inserted into the empty space S″, the tubular nut 110′ may be prevented from rotating, and thus the pipe hanger 10′ may remain coupled to the pipe 40′ to support the pipe 40′.

In particular, as the tubular nut 110′ and the pipe hanger 10′ are magnetic while the spacer 130 is formed of a magnet, when an operator holds and positions the spacer 130 near the empty space S″ to insert the spacer 130 into the empty space S″, the spacer 130 is attracted to and seated in the empty space S″ by magnetic force.

In addition, when the spacer 130 is removed from the empty space S″, the spacer 130 can be pushed out in the longitudinal direction of the pipe 40′ using a tool not shown. Thereby, the spacer 130 may be decoupled.

In the first and second embodiments, the spacer 130 may be formed in any shape capable of making surface contact with at least one of is brought into surface contact with the upper horizontal part 12 and the vertical part 13 of the carrying bar hanger 10 or the pipe hanger 10′ while making surface contact with the lower nut 110, the upper nut 120, or the flange 111 of the tubular nut 110′. For example, it may be a cylindrical body, a hexahedron, a triangular column, or the like that has two or more flat surfaces.

The spacer 130 may be formed to have a hexahedral shape to make surface contact with both with the upper horizontal part 12 and the vertical part 13 of the carrying bar hanger 10 or the pipe hanger 10′ while making surface contact with the lower nut 110, the upper nut 120, or the flange 111 of the tubular nut 110′.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

1. A holding means for maintaining a tightened state between a carrying bar hanger and an anchor bolt, comprising:
a lower nut formed to have a size and shape defining an empty space between an upper horizontal part and an upper portion of a vertical part bent at one end of the upper horizontal part and extending downward when fastened to an anchor bolt arranged through a through hole formed in the upper horizontal part of a carrying bar hanger and brought into close contact with a bottom surface of the upper horizontal part;
an upper nut fastened to the anchor bolt arranged through the through hole and brought into close contact with a top surface of the upper horizontal part; and
a spacer interposed in the empty space to make a close contact with an upper portion of the vertical part and the lower nut to prevent rotation of the lower nut, or a bracket piece bent at an opposite end of the upper horizontal part and extending upward and a spacer interposed in a second empty space between the upper nut and the upper horizontal part to make surface contact with the bracket piece and the upper nut to prevent rotation of the upper nut.

2. The holding means of claim 1, wherein the spacer is formed of a magnet, and the hanger and either the lower nut or the upper nut are formed to be magnetic.

3. The holding means of claim 1, wherein the spacer makes surface contact with the bottom surface or top surface of the upper horizontal part.

4. The holding means of claim 1, wherein the lower nut or the upper nut is a hexagonal nut.

5. A holding means for maintaining a tightened state between an anchor bolt embedded in a concrete ceiling and a pipe hanger to suspend a pipe from the ceiling, the pipe hanger including a mount part mounted on the anchor bolt and a clamping part detachably coupled to a lower end of the mount part to clamp a pipe, the holding means comprising:
a tubular nut a threaded inner circumferential surface screwed to the anchor bolt;
a flange expanding from the lower end of the tubular nut to allow a bottom surface of an upper horizontal part of the pipe hanger to be seated with the tubular nut arranged through a through hole formed in the upper horizontal part of the mount part of the pipe hanger; and
a spacer interposed in another empty space defined between the upper horizontal part of the pipe hanger and an upper portion of the vertical part bent at one side of the upper horizontal part and extending downward to make surface contact with the upper portion of the vertical part and the flange to prevent rotation of the pipe hanger.

6. The holding means of claim 5, wherein the spacer is formed of a magnet, and the tubular nut and the pipe hanger are formed to be magnetic.

7. The holding means of claim 5, wherein the spacer makes surface contact with the bottom surface of the upper horizontal part.

8. The holding means of claim 1, wherein a portion of the flange facing the vertical part is chamfered to have a flat portion parallel to the vertical part.
